(19) United States
(12) Patent Application Publication
(10) Pub. No.: US 2018/0345834 A1
(43) Pub. Date: Dec. 6, 2018

(54) CAPACITIVE VEHICLE SEAT OCCUPANCY DETECTION SYSTEM WITH DETECTION OF VEHICLE SEAT HEATER MEMBER INTERRUPTION

(71) Applicant: IEE INTERNATIONAL ELECTRONICS & ENGINEERING S.A.

(72) Inventors: Oliver LION, Merzig (DE); Christian URIG, Püttlingen (DE)

(21) Appl. No.: 15/515,504

(22) PCT Filed: Sep. 30, 2015
(86) PCT No.: PCT/EP2015/072649

§ 371 Date: Mar. 29, 2017

(30) Foreign Application Priority Data
Sep. 30, 2014 (LU) LU 92 562

(51) Int. Cl. B60N 2/56; B60N 2/00; G05B 19/042

(52) U.S. Cl. CPC B60N 2/5685; G05B 2219/25257; G05B 19/042; B60N 2/002

(57) ABSTRACT

A capacitive detection system for detecting occupancy of a vehicle seat includes a signal generating unit and a signal evaluation unit. The vehicle seat has a seat heater member configured for receiving pulse-width modulated electrical heater power of a pulse-width modulation frequency and time-varying output signals of the signal generating unit. The signal evaluation unit is configured to monitor a voltage difference between the electrical connection ends of the seat heater member, and is further configured to generate an output signal that is indicative of the seat heater member to be defective, on the basis of a fulfillment of at least one predetermined condition concerning the monitored voltage difference and a phase of the pulse-width modulated electrical heater power.

### TECHNICAL FIELD

The invention relates to a capacitive vehicle seat occupancy detection system, a method of operating such capacitive vehicle seat occupancy detection system, in particular a method of operating the system for detecting a defective seat heater member, and a software module for carrying out the method.

### BACKGROUND ART

Vehicle seat occupancy detection devices are nowadays widely used in vehicles, in particular in passenger cars, for providing a seat occupancy signal for various appliances, for instance for the purpose of a seat belt reminder (SBR) system or an activation control for an auxiliary restraint system (ARS). Seat occupancy detection devices include seat occupancy sensors that are known to exist in a number of variants, in particular based on capacitive sensing. An output signal of the seat occupancy detection device is usually transferred to an electronic control unit of the vehicle to serve, for instance, as a basis for a decision to deploy an air bag system to the vehicle seat.

It is further known in the art to use a portion of an electric seat heater of a vehicle seat as a sensor in a capacitive vehicle seat occupancy detection system. For example, patent application publication DE 41 10 702 A1 describes a vehicle seat with an electric seat heater comprising a conductor which can be heated by the passage of electrical current through it. The conductor is located in the seating surface and forms a part of a capacitive sensor for detecting a seat occupancy of the seat.

In vehicle seats that are equipped with one or more seat heater members, it is known to be beneficial to incorporate at least one seat heater member in a capacitive measurement of a vehicle seat occupancy detection device, due to an inherent strong capacitive coupling to a seat frame of the vehicle seat and the benefit of hardware savings.

In such vehicle seats there exists a risk of compromising the reliability of the seat occupancy detection device by a failure of the seat heater member that is involved in the capacitive measurement. Therefore, detection of a failure of the involved seat heater member, for instance a physical interruption, at all times is desirable. However, the capacitive measurement that may serve this purpose is compromised in case of continuously providing electrical power to the at least one seat heater member.

In a conventional approach, a detection of a failure of the involved seat heater member can for instance be carried out by a cost-intensive electric current measurement, for instance by using an internal integrity check circuit with a constant current, which would imply an increase in size of a printed circuit board, and also an increase in power dissipation and costs.

It is therefore desirable to provide a capacitive vehicle seat occupancy detection system with an improved capability of detecting failures of a seat heater member that is involved in the capacitive measurement of the vehicle seat occupancy detection system at all times.

### SUMMARY

In one aspect of the present invention, there is provided a combined seat heater and capacitive seat occupancy detection system, wherein the seat heater comprises at least one seat heater member having electrical connection ends for receiving pulse-width modulated electrical heater power of a pulse-width modulation frequency, and the capacitive vehicle seat occupancy detection system includes
a signal generating unit provided for generating a time-varying output signal, wherein the signal generating unit is configured to be electrically connectable to at least one of the electrical connection ends of the at least one seat heater member for providing the time-varying output signal at least to the at least one seat heater member, and
a signal evaluation unit that is provided for sensing an electrical quantity that is indicative of a capacitance of the at least one seat heater member, and that is provided for generating an output signal that is representative of the sensed capacitance. This output signal is then usable as a basis for at least one out of detecting and classifying a seat occupancy by comparison to at least a first predetermined value for the sensed capacitance. The seat occupancy classification may comprise at least two classes selected out of a group formed by classes “empty”, “child” and “adult”.

Furthermore, the signal evaluation unit is configured to monitor a voltage difference between the electrical connection ends of the at least one seat heater member, and is further configured to generate an output signal that is indicative of the at least one seat heater member to be defective, on the basis of a fulfilment of at least one predetermined condition concerning the monitored voltage difference.

It is noted herewith that the terms “first”, “second”, etc. are used for distinction purposes only and are not meant to indicate or anticipate a sequence or a priority in any way.

The term “electrically connectable”, as used in this application, shall be understood to encompass galvanic electrical connections as well as connections established by capacitive and/or inductive electromagnetic coupling.

The term “sensed capacitance”, as used in this application, shall be understood to encompass an absolute measurement of a capacitance value as well as a measurement of a capacitance value relative to an arbitrarily determined capacitance zero.

The seat heater may comprise a seat heater control unit that is configured to provide pulse-width modulated electrical heater power of a pulse-width modulation frequency to at least one seat heater member. The term “phase of the pulse-width modulated electrical heater power”, as used in this application, shall be understood as either a state of electric power of a predetermined power level being provided to the at least one seat heater member (“ON”) or a state of zero electric power being provided to the at least one seat heater member (“OFF”).

The seat heater control module may be further configured for performing a diagnosis operation during which the heater power is switched off and a checking a temperature sensor is read out, for instance an NTC (negative temperature coefficient) temperature sensor that is installed in the vehicle seat for temperature control. Such diagnosis operations occur e.g. each second for at least 5 ms. This means that a PWM cycle, during which the seat heater control module provides pulse-width modulated electrical heater power to the heater element is not longer than 995 ms and that two adjacent PWM cycles are separated by a diagnosis cycle of the seat heater control module.

With the combined seat heater and capacitive seat occupancy detection system according to the present invention, a cost-effective and hardware-effective way to detect a failure of a seat heater member that is involved in a capacitive measurement of the capacitive vehicle seat occupancy detection system can be accomplished during a phase of the pulse-width modulated electrical heater power in which a momentary electrical heater power is zero.

In fact, if the seat heater control module is switched on but the momentary electrical heater power is zero, the configuration is such that the first electrical connection end of the seat heater member is connected to the battery voltage and the second connection end is disconnected from ground. If the seat heater member is intact, the second connection end will be at the same potential than the first connection end as no current is flowing into ground. A voltage difference between the first and second connection end is then substantially equal to 0 V. If however the seat heater member is broken or defective, the second connection end will be free floating and a voltage difference between the first and second connection end will not be equal to 0 V but exceed a specific threshold value. Based on the comparison of the voltage difference between the first and second connection end with the corresponding threshold value, the output signal that is indicative of the at least one seat heater member to be defective

During a phase of the pulse-width modulated electrical heater power in which a momentary electrical heater power is high, i.e. if a predetermined power level is provided to the at least one seat heater member (“ON”), the configuration is such that the first electrical connection end of the seat heater member is connected to the battery voltage and the second connection end is connected to ground. In this case, a voltage difference between the first and second connection end is substantially equal to the battery voltage, as well for the intact heater member as well for the broken heater member. This means however that a defective heater member may not be easily identified during heater member “ON”. Especially if the heater operates on a 100% PWM, i.e. if the heater member is powered during the entire PWM cycle, a diagnosis during single PWM cycle is not possible.

In order to solve this problem, the present invention, in at least some embodiments, further proposes to monitor the voltage difference between the first and the second connection and over a period of more than one PWM cycle, if the voltage difference exceeds the threshold value during an entire PWM cycle. This allows to detect the diagnosis operation of the seat heater control module, which occurs between two PWM cycles and during which a momentary electrical heater power is zero. In fact, if the system detects, after a complete PWM cycle in which the voltage difference exceeds the predetermined threshold, that the voltage difference drops below the threshold, it can determine that the second connection end is raised to the same potential than the first connection end and that accordingly the seat heater member has to be intact.

In a preferred embodiment, the seat heater accordingly comprises a seat heater control unit that is configured to alternately provide pulse-width modulated (PWM) electrical heater power to the at least one seat heater member during a PWM time interval (PWM cycle) and perform a diagnostic operation during a diagnostic time interval. The pulse-width modulated (PWM) electrical heater power is for instance provided by periodically connecting and disconnecting one of said first and second connection end to, respective from, ground by means of a respective switch. Alternatively the pulse-width modulated (PWM) electrical heater power may be provided by periodically connecting and disconnecting one of said first and second connection end to, respective from, a corresponding power source, such as the vehicle battery by means of a respective switch.

The signal evaluation unit is then configured to perform, during a first predetermined time interval of a length corresponding to the length of a PWM time interval, the steps of
a) sampling the monitored voltage difference periodically (n samples) and comparing the sampled voltage difference with a first threshold value (Vₜₕᵣₑₛₕ)
b) increase a counter value each time that the sampled voltage difference exceeds the first threshold value, and
c) after the n samples, comparing the counter value with a predetermined second threshold value (Cₜₕᵣₑₛₕ), and
d) assessing that the seat heater member is not defective if said counter value is lower than said second threshold value (Cₜₕᵣₑₛₕ).

The signal evaluation unit is preferably further configured to perform, if in step c) said counter value is higher than or equal to said second threshold value, the steps of
monitoring, during a second predetermined time interval of a length corresponding to the length of a PWM time interval, a voltage at the respective connection end that is disconnected from the respective one of ground or power source during a phase of the pulse-width modulated electrical heater power in which a momentary electrical heater power is zero, and
assessing that the seat heater member is not defective if a variation of the voltage at the respective switched connection end exceeds a specific threshold value or generating said output signal that is indicative of the at least one seat heater member to be defective if variation of the voltage at the respective switched connection end does not exceed said specific threshold value.

It will be noted, that if the heater member is powered at a duty cycle of 100% during the first predetermined time interval, the second predetermined time interval will necessarily contain a diagnostic time interval in which the seat heater control unit performs a diagnostic operation. During this diagnostic operation, the seat heater member is not powered and therefore the voltage difference between the connection ends will drop below the threshold value if the seat heater is intact.

If for instance the “ground” connection end of the heater member is disconnected during “power off”, the voltage at this ground connection end will raise to the battery voltage if the seat heater is intact and the corresponding voltage shift may be easily detected by the signal evaluation unit. Likewise, if the “high potential” connection end of the heater member is disconnected from the vehicle battery during “power off”, the voltage at this “high potential” connection end will drop down to ground potential (0 V) if the seat heater is intact and the corresponding voltage drop may be easily detected by the signal evaluation unit.

A simple voltage measurement at the “switched” connection end enables the signal evaluation unit accordingly to assess that the seat heater member is intact. If on the contrary no significant voltage variation is detected during the second predetermined time interval, the signal evaluation unit is configured to generate the output signal that is indicative of the at least one seat heater member being defective.

The first threshold value (Vₜₕᵣₑₛₕ) for the voltage difference is preferably lower than 1 V (0V≤Vₜₕᵣₑₛₕ≤1V). The first threshold value may e.g. be substantially equal to 0V. The second threshold value (Cₜₕᵣₑₛₕ) is preferably higher than 90% of the number of samples n (0.9·n≤Cₜₕᵣₑₛₕ≤n) and preferably higher than 95% of the number of samples n (0.95·n≤Cₜₕᵣₑₛₕ≤n). If for instance a total of 64 samples are taken during a predetermined time interval, the second threshold may e.g be equal to 62.

With the above configuration, a cost-effective and hardware-effective way to detect a failure of a seat heater member that is involved in a capacitive measurement of the capacitive vehicle seat occupancy detection system can be accomplished at almost all times while the seat heater member is being provided with pulse-width modulated electrical heater power at a duty cycle that is equal to 100%.

In a further embodiment, the signal generating unit includes a first current source and a second current source for providing a diagnostic output signal, and the first current source is electrically connectable to one electrical connection end of the at least one seat heater member and the second current source is electrically connectable to the other electrical connection end of the at least one seat heater member. In this embodiment, the diagnostic output signal can be applied to the heater member if the seat heater control module is not on, i.e. when the vehicle battery voltage is not usable for diagnosis.

In another aspect of the invention, a vehicle seat is provided that comprises an embodiment of the disclosed capacitive vehicle seat occupancy detection system. The vehicle seat comprises a seat base that is configured for taking up a seat base cushion, wherein the seat base and the seat base cushion are provided for supporting a bottom of a seat occupant. The vehicle seat further includes a backrest that is configured for taking up a backrest cushion provided for supporting a lumbar and back region of the seat occupant. Moreover, the vehicle seat includes a seat heater control unit that is configured to provide pulse-width modulated electrical heater power of a pulse-width modulation frequency to at least one seat heater member.

Then, the vehicle seat comprises at least one seat heater member that is at least partially arranged at at least one out of the seat base cushion and the backrest cushion, and has electrical connection ends that are connected to the seat heater control unit for receiving the pulse-width modulated electrical heater power. The at least one seat heater member is electrically connected to the signal generating unit of the capacitive vehicle seat occupancy detection system.

In this way, a heatable vehicle seat with a capacitive vehicle seat occupancy detection system can be provided with a capability of detecting failures of a seat heater member that is involved in the capacitive measurement of the vehicle seat occupancy detection system at almost all times.

In yet another aspect of the invention, a method of operating a capacitive vehicle seat occupancy detection system, in particular a method of operating the system for detecting a defective seat heater member of a vehicle seat is proposed. A desired heating of the vehicle seat is designed to be carried out by providing pulse-width modulated electrical heater power of a pulse-width modulation frequency from a seat heater control unit that is connected to electrical connection ends of the at least one seat heater member.

A time-varying output signal is being provided at least to the electrical connection ends of the at least one seat heater member for sensing an electrical quantity that is indicative of a capacitance of the at least one seat heater member. The capacitance is usable as a basis for at least one out of detecting and classifying a seat occupancy by comparison to at least a first predetermined value for the sensed capacitance.

The method further comprises steps of
monitor a voltage difference between the electrical connection ends of the at least one seat heater member and
generate an output signal that is indicative of the at least one seat heater member to be defective, on the basis of a fulfillment of at least one predetermined condition concerning the monitored voltage difference.

During a phase of the pulse-width modulated electrical heater power in which a momentary electrical heater power is zero, the method may simply comprise the steps of:
determining a voltage difference between the electrical connection ends of the at least one seat heater member,
checking if the determined voltage difference exceeds a predetermined third threshold value that is larger than zero, and
generating an output signal that is indicative of the at least one seat heater member to be defective if the determined voltage difference exceeds the predetermined third threshold value.

During a phase of the pulse-width modulated electrical heater power in which a momentary electrical heater power is zero, the electrical connection ends of the at least one seat heater member are expected to have an identical voltage level if the at least one seat heater member is fully functional, and thus a determined voltage difference is expected to be zero. Any deviation from a zero voltage difference therefore is an indication of a failure of the seat heater member or one of its electrical connections.

During a phase of the pulse-width modulated electrical heater power in which the momentary electrical heater power is larger than zero, the electrical connection ends of the at least one seat heater member are expected to have different voltage levels if the at least one seat heater member is fully functional, because a heater current is driven through the at least one seat heater member.

In a preferred embodiment, the method therefore comprises, during a first predetermined time interval of a length corresponding to the length of a PWM time interval, the steps of
a) sampling the monitored voltage difference periodically (n samples) and comparing the sampled voltage difference with a first threshold value (Vₜₕᵣₑₛₕ)
b) increase a counter value each time that the sampled voltage difference exceeds the first threshold value, and
c) after the n samples, comparing the counter value with a predetermined second threshold value (Cₜₕᵣₑₛₕ), and
d) assessing that the seat heater member is not defective if said counter value is lower than said second threshold value (Cₜₕᵣₑₛₕ).

If the counter value is higher than or equal to said second threshold value, the method preferably further comprises the steps of
monitoring, during a second predetermined time interval of a length corresponding to the length of a PWM time interval, said second predetermined time interval being adjacent to said first predetermined time interval, a voltage at the respective connection end that is disconnected from the respective one of ground or power source during a phase of the pulse-width modulated electrical heater power in which a momentary electrical heater power is zero, and
assessing that said seat heater member is not defective if a variation of the voltage at the respective connection end exceeds a specific threshold value during said second predetermined time interval or generating said output signal that is indicative of the at least one seat heater member to be defective if variation of the voltage at the switched connection end does not exceed said specific threshold value.

In this way, the described capacitive vehicle seat occupancy detection system can be operated to detect a failure of a seat heater member that is involved in a capacitive measurement of the capacitive vehicle seat occupancy detection system at almost all times while the seat heater member is being provided with pulse-width modulated electrical heater power at a duty cycle that is close to or equal to 100%.

In one embodiment, the step of checking if the determined voltage difference exceeds a predetermined threshold value includes low-pass filtering of a voltage at one of the electrical connection ends of the at least one seat heater member. By that, a misinterpretation of the monitored voltage difference, for instance due to electromagnetic interference can be avoided and the reliability of a result of the step of checking can be improved.

In one embodiment, the method steps may be carried out automatically and periodically.

In yet another aspect of the invention, a software module for controlling an automatic execution of steps of an embodiment of the method disclosed herein is provided.

The method steps to be conducted are converted into a program code of the software module, wherein the program code is implementable in a digital memory unit of the capacitive vehicle seat occupancy detection system and is executable by a processor unit of the capacitive vehicle seat occupancy detection system. Preferably, the digital memory unit and/or processor unit may be a digital memory unit and/or a processing unit of the evaluation unit of the capacitive vehicle seat occupancy detection system. The processor unit may, alternatively or supplementary, be another processor unit that is especially assigned to execute at least some of the method steps.

The software module can enable a robust and reliable execution of the method and can allow for a fast modification of method steps.

These and other aspects of the invention will be apparent from and elucidated with reference to the embodiments described hereinafter.

### BRIEF DESCRIPTION OF THE DRAWINGS

Preferred embodiments of the invention will now be described, by way of example, with reference to the accompanying drawings, in which:

FIG. 1 schematically illustrates a configuration of an embodiment of a capacitive vehicle seat occupancy detection system in accordance with the invention as being partially installed in a vehicle seat of a passenger car;

FIG. 2 illustrates a view onto details of a layout of the embodiment of a capacitive vehicle seat occupancy detection system pursuant to FIG. 1; and

FIG. 3 is a flow chart of an embodiment of the method in accordance with the invention.

### DESCRIPTION OF PREFERRED EMBODIMENTS

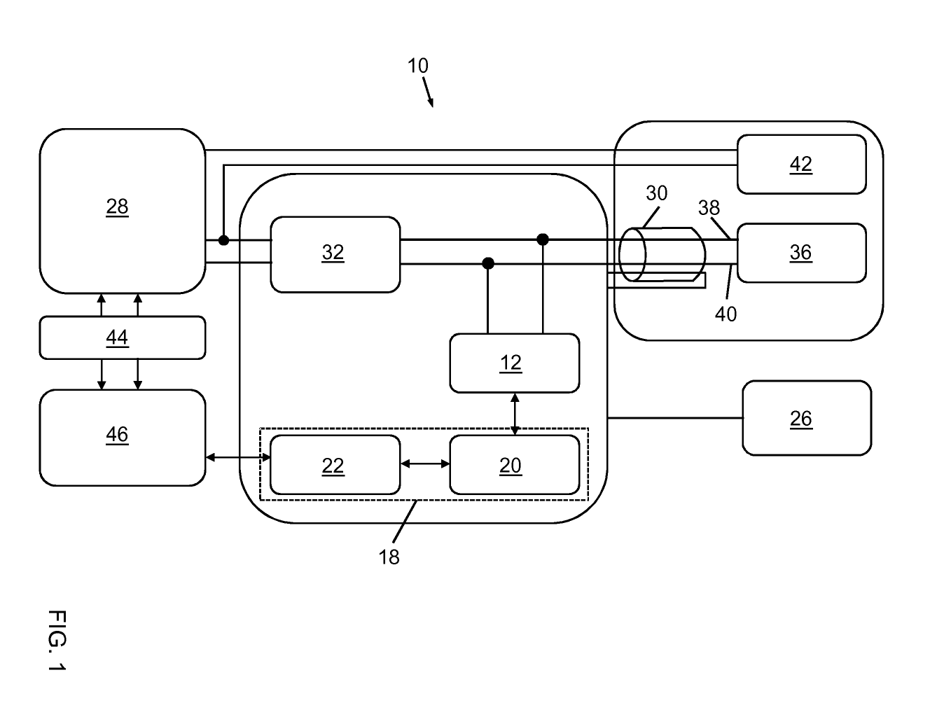

FIG. 1 schematically illustrates a configuration of an embodiment of a capacitive vehicle seat occupancy detection system 10 in accordance with the invention as being partially installed in a vehicle seat 26 of a passenger car.

The vehicle seat includes a seat base 26, i.e. a seat frame or seat pan, configured for taking up a seat base cushion, the seat base and the seat base cushion being provided for supporting a bottom of a seat occupant. The vehicle seat further comprises a backrest configured for taking up a backrest cushion provided for supporting a lumbar and back region of the seat occupant. Seats of this kind are well known in the art and shall therefore neither shown in a figure nor be described in further detail herein.

The vehicle seat may comprise a plurality of seat heater members that are formed e.g. by pieces of electric wires made from a copper-nickel alloy with low temperature coefficient, such as Constantan®, and having an outer electrical insulation layer. Alternatively the seat heater members may comprise printed traces of a resistive material on a carrier layer, for instance traces of a PTC material (positive temperature coefficient). The seat heater members 36 are arranged in a meandering manner at various locations of the vehicle seat, as is known in the art. One seat heater member 36 may e.g. be attached to a seat base cushion front member, and two more seat heater members 36 may be attached to a two-part seat base cushion center member, close to the A surface of the seat base cushion. The meandering patterns formed by the seat heater members cover a major portion of the surface of the seat base cushion center member. The seat heater members comprise electrical connection ends 38, 40 for receiving pulse-width modulated electrical heater power of a pulse-width modulation frequency.

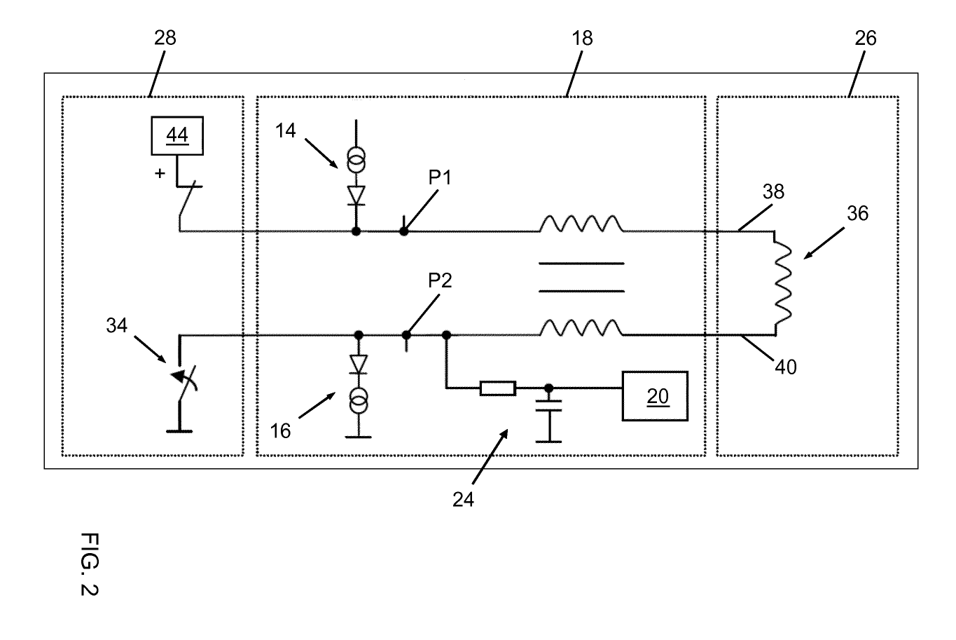

The vehicle further comprises a seat heater control unit 28 that is connected to a battery 44 of the vehicle (FIG. 2). The seat heater control unit 28 is configured to provide pulse-width modulated electric power of variable duty cycle to the seat heater members 36. To this end, the electrical connection ends 38, 40 of each one of the plurality of seat heater members are electrically connected to the seat heater control unit 28 by shielded cables 30 and via common mode chokes 32 for decoupling purposes (exemplarily shown for seat heater member 36 in FIG. 1). The pulse-width modulation is symbolized in FIG. 2 by a switch 34 meaning that in this specific embodiment a ground line which usually has a common voltage potential to a chassis of the vehicle, is switched (“low side switch”) to generate the pulse-width modulated electric power. In other embodiments, a line connected to the positive terminal of the battery 44 may be switched (“high side switch”) to generate the pulse-width modulated electric power. The seat heater control unit 28 includes a temperature sensor 42, e.g. a thermistor made of an NTC material (negative temperature coefficient), that is arranged at an appropriate position in the vehicle seat 26 and that is configured for providing signals indicative of a temperature of the vehicle seat 26 to the seat heater control unit 28 for control purposes.

Moreover, the capacitive vehicle seat occupancy detection system 10 includes a signal generating unit 12 and a signal evaluation unit 18, which are installed remotely from the vehicle seat 26.

The signal generating unit 12 is provided for generating a time varying output signal, e.g. a sinusoidal wave signal or square-wave signal, and for applying the output signal to seat heat member 36. The time-varying output signal may e.g. be designed as a sinusoidal wave signal with a frequency of 100 kHz but other signal forms and/or frequencies are also contemplated that appear to be suitable to the person skilled in the art. The electrical connection ends 38, 40 of the seat heater member 36 are connected to the signal generating unit 12 to enable applying the time-varying output signal.

The electrical connection ends 38, 40 of the seat heater member 36 are connected to the signal generating unit 12 which, in turn, is connected to the signal evaluation unit 18 (FIG. 1). The signal evaluation unit 18 comprises a micro-controller 20 (FIG. 2) and is provided for sensing an electrical quantity that is indicative of a capacitance of the seat heater member 36 that is connected to the signal generating unit 12.

The signal evaluation unit 18 is further provided for generating an output signal that is representative of the sensed capacitance and that is usable as a basis for detecting and classifying a seat occupancy by comparison to predetermined values for a sensed capacitance. In this specific embodiment, the signal evaluation unit 18 is configured to generate output signals representing seat occupancy classes “child/unoccupied seat” (class 1) and “adult” (class 2). In other embodiments, different seat occupancy classes may be chosen that appear to be suitable to the person skilled in the art.

Referring again to FIG. 1, the signal evaluation unit 18 is equipped with a communication interface 22 that is connected to an airbag control unit 46 of the vehicle, and is configured for transferring output signals to the airbag control unit 46 for the purpose of air bag activation control. For instance, if the transferred output signal represents the occupancy class “adult”, an airbag of the vehicle seat will be deployed.

In order to be able to detect a failure in the seat heater element used for capacitive sensing, the signal evaluation unit 18 is further configured to monitor a voltage difference between the electrical connection ends 38, 40 of the seat heater member 36 that is connected to the signal generating unit 12 by determining the voltage difference between measuring points P1, P2 (FIG. 2), and is also configured to generate an output signal that is indicative of the seat heater member 36 to be defective, on the basis of a fulfillment of at least one predetermined condition concerning the monitored voltage difference, as will be described in more detail in the following.

For the purpose of monitoring the voltage difference, the signal evaluation unit 18 includes e.g. a low-pass filter 24 connected to one of the electrical connection ends 40 of the seat heater member 36.

From the layout shown in FIG. 2 it is evident to those skilled in the art that during a phase of the pulse-width modulated electrical heater power in which the momentary electrical heater power is larger than zero, a voltage difference between measuring points P1, P2 is the same for a functional seat heater member 36 and a defective seat heater member 36. In particular, a distinction between a functional seat heater member 36 and a defective seat heater member 36 is not possible by determining the voltage difference between the measuring points P1, P2 in case that pulse-width modulated electrical heater power is provided at a duty cycle of 100%.

During a phase of the pulse-width modulated electrical heater power in which the momentary electrical heater power is zero and the electrical connections are established as shown in FIG. 2, a voltage difference between the measuring points P1, P2 is zero for a functional seat heater member 36, and is larger than zero for a defective seat heater member 36. A summary of expected voltage differences between the measuring points P1, P2 for various scenarios is given in table 1 below.

TABLE 1

| | momentary electrical heater | | | momentary electrical heater | | |
|---|---|---|---|---|---|---|
| | power is larger than zero | | | power is zero | | |
| | potential | potential | voltage | potential | potential | voltage |
| scenario | at P1 | at P2 | difference | at P1 | at P2 | difference |
| seat heater | 12 V | 0 V | 12 V | 12 V | 12 V | 0 V |
| member functional | | | | | | |
| seat heater | 12 V | 0 V | 12 V | 12 V | <12 V | >0 V |
| member defective | | | | | | |
| counter increase ? | | | YES | | | NO |

It will be noted that a third scenario occurs if the seat heater control unit 28 is not switched on, i.e. if the 12 V of the battery 44 are not applied to measurement point P1. In order to be able to detect a defective seat heater in this scenario, the signal generating unit 12 furthermore includes its own on-board diagnosis circuit comprising a first current source 14 and a second current source 16 for providing an output diagnosis signal (FIG. 2), e.g. a diagnosis voltage of about 3 V, which can be applied across the connection ends 38, 40 of the seat heater member 36. The first current source 14 is electrically connected to one electrical connection end 38 of the seat heater member 36 and the second current source 16 is electrically connected to the other electrical connection end 40 of the seat heater member 36. If the seat heater member 36 is intact, the diagnostic voltage is detected at both measuring points P1, P2. If however the potential at measuring point P2 is lower than the diagnostic voltage, a defect of the seat heater element may be reliably detected.

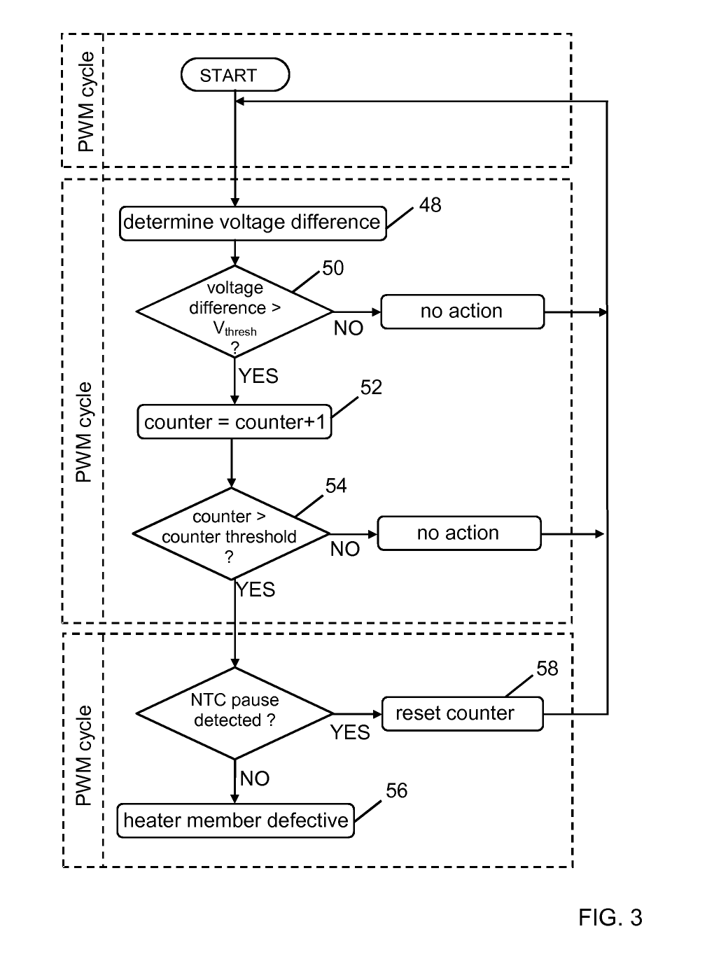

Hereinafter, an embodiment of a method of operating the capacitive vehicle seat occupancy detection system 10, in particular a method of operating the system 10 for detecting a defective seat heater member 36 of the vehicle seat 26 is described. A flow chart of the method is given in FIG. 3. In preparation of operating the capacitive vehicle seat occupancy detection system 10, it shall be understood that all involved units, devices and systems are in an operational state and configured as illustrated in FIGS. 1 and 2.

In order to be able to carry out the method, the signal evaluation unit comprises a software module. The method steps to be conducted are converted into a program code of the software module. The program code is implemented in a digital data memory unit of the signal evaluation unit 18 and is executable by a processor unit of the signal evaluation unit 18. The digital data memory unit and the processor unit are components of the micro-controller 20. Alternatively, the software module may as well reside in and may be executable by a control unit of the vehicle, for instance by the airbag control unit 46, and established data communication means 22 between the signal evaluation unit 18 and the airbag control unit 46 of the vehicle could be used for enabling mutual transfer of data.

In this specific embodiment of the method, a momentary phase of the pulse-width modulated electrical heater power is monitored by a simple counter member as follows. In other embodiments of the method, different means may be chosen that appear to be suitable to the person skilled in the art.

In a first step 48 of the method, a voltage difference between the electrical connection ends 38, 40 of the seat heater member 36 is monitored during a predetermined time interval of a length corresponding to the length of a PWM time interval one PWM cycle by taking a plurality of samples of the voltage difference between the electrical connection ends 38, 40 of the seat heater member 36 connected to the signal generating unit 12. The diagnosis takes for instance 64 samples during one PWM cycle of the seat heater control unit. After each sampling, it is checked in step 50, if the determined voltage difference exceeds a predetermined threshold value Vₜₕᵣₑₛₕ for the voltage difference that is larger than zero, for instance Vₜₕᵣₑₛₕ=1.0 V. If the condition is not fulfilled, i.e. if the voltage difference is lower than or equal to Vₜₕᵣₑₛₕ, the next sampling is started. If the condition is fulfilled, a counter value is increased by one in a next step 52.

After the required number of samplings is made, i.e. after 64 samples, the momentary counter value is compared to an appropriately selected predetermined counter threshold value in step 54. In this specific embodiment with a total of 64samples taken per PWM cycle, the counter threshold value may e.g. be set to 62. In other embodiments of the method, a different predetermined counter threshold value may be chosen that appears to be suitable to the person skilled in the art. If the momentary counter value is less than or equal to the predetermined counter threshold value, it is determined that during the PWM cycle the voltage difference was dropped below the threshold value (during a non heating period) and accordingly the seat heater member 36 is assessed to be fully functional and the next diagnostic cycle may be started.

If however the momentary counter value is larger than the predetermined counter threshold value, i.e. the voltage difference was exceeding the threshold value Wrest, during substantially the entire PWM cycle, then either

the duty cycle of the pulse-width modulated electrical heater power is 100%, or
the seat heater member 36 is defective.

If the heater member is powered at a duty cycle of 100% during the first predetermined time interval, the second, adjacent predetermined time interval will necessarily contain a diagnostic time interval in which the seat heater control unit performs a diagnostic operation. During this diagnostic operation, the seat heater member is not powered and therefore the voltage difference between the connection ends will drop below the threshold value if the seat heater is intact.

In order to detect the occurrence of a diagnostic operation by the seat heater control unit, the signal evaluation unit (18) will monitor, during a second predetermined time interval, a voltage at measuring point P2, i.e. at the respective connection end that is disconnected from ground during a diagnostic operation of the seat heater control unit.

If no voltage shift is detected by the microcontroller 20 during the second predetermined time interval, i.e. if no NTC pause is detected, an output signal that is indicative of the seat heater member 36 to be defective is generated in step 56 by the signal evaluation unit 18.

If the voltage at P2 briefly raises to 12 V during the second predetermined time interval, due to switch 34 being opened during the diagnostic operation (NTC pause), the signal evaluation unit 18 can determine that an NTC pause has occurred and assess that the seat heater member 36 is fully functional. The counter is then reset in a next step 58, and the sampling of the voltage difference is resumed.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

1. A combined seat heater and capacitive seat occupancy detection system, wherein the seat heater comprises at least one seat heater member having electrical connection ends for receiving pulse-width modulated electrical heater power of a pulse-width modulation frequency, and the capacitive seat occupancy detection system includes
a signal generating unit provided for generating a time-varying output signal, wherein the signal generating unit is configured to be electrically connectable to at least one of said electrical connection ends of the at least one seat heater member for providing the time-varying output signal at least to the at least one seat heater member,
a signal evaluation unit that is provided for sensing an electrical quantity that is indicative of a capacitance of the at least one seat heater member, and that is provided for generating an output signal that is representative of the sensed capacitance,
wherein the signal evaluation unit is configured to monitor a voltage difference between the electrical connection ends of the at least one seat heater member, and is further configured to generate an output signal that is indicative of the at least one seat heater member being defective, when the voltage difference meets at least one predetermined condition.

2. The combined seat heater and capacitive seat occupancy detection system as claimed in claim 1, wherein the seat heater comprises a seat heater control unit that is configured to alternately provide pulse-width modulated (PWM) electrical heater power to the at least one seat heater member during a PWM time interval and perform a diagnostic operation during a diagnostic time interval, said pulse-width modulated (PWM) electrical heater power being provided by periodically connecting and disconnecting one of said first and second connection end to, respective from, a respective one of a power source and ground, and wherein the signal evaluation unit is configured to perform, during a first predetermined time interval of a length corresponding to the length of a PWM time interval, the steps of
a) sampling the monitored voltage difference periodically (n samples) and comparing the sampled voltage difference with a first threshold value (Vₜₕᵣₑₛₕ),
b) increase a counter value each time that the sampled voltage difference exceeds the first threshold value,
c) after the n samples, comparing the counter value with a predetermined second threshold value (Cₜₕᵣₑₛₕ), and
d) assessing that the seat heater member is not defective if said counter value is lower than said second threshold value (Cₜₕᵣₑₛₕ).

3. The combined seat heater and capacitive seat occupancy detection system as claimed in claim 2, wherein said signal evaluation unit is configured to perform, if in step c) said counter value is higher than or equal to said second threshold value, the steps of
monitoring, during a second predetermined time interval of a length corresponding to the length of a PWM time interval, said second predetermined time interval being adjacent to said first predetermined time interval, a voltage at the respective connection end that is disconnected from the respective one of ground or power source during a phase of the pulse-width modulated electrical heater power in which a momentary electrical heater power is zero, and
assessing that said seat heater member is not defective if a variation of the voltage at the respective connection end exceeds a specific threshold value during said second predetermined time interval or generating said output signal that is indicative of the at least one seat heater member to be defective if variation of the voltage at the switched connection end does not exceed said specific threshold value.

4. The combined seat heater and capacitive seat occupancy detection system as claimed in claim 2, wherein said first threshold value (Vₜₕᵣₑₛₕ) is lower than 1 V (0V≤Vₜₕᵣₑₛₕ≤1V).

5. The combined seat heater and capacitive seat occupancy detection system as claimed in claim 2, wherein said second threshold value (Cₜₕᵣₑₛₕ) is higher than 90% of the number of samples n (0.9·n≤Cₜₕᵣₑₛₕ≤n) and preferably higher than 95% of the number of samples n (0.95·n≤Cₜₕᵣₑₛₕ≤n).

6. The combined seat heater and capacitive seat occupancy detection system as claimed in claim 1, wherein the signal generating unit further includes a first current source and a second current source for providing a diagnostic output signal, and wherein the first current source is electrically connectable to one electrical connection end of the at least one seat heater member and the second current source is electrically connectable to the other electrical connection end of the at least one seat heater member.

7. A vehicle seat with a capacitive vehicle seat occupancy detection system as claimed in claim 1, the vehicle seat comprising
a seat base configured for taking up a seat base cushion, the seat base and the seat base cushion being provided for supporting a bottom of a seat occupant,
a backrest configured for taking up a backrest cushion provided for supporting a lumbar and back region of the seat occupant,
a seat heater control unit that is configured to provide pulse-width modulated electrical heater power of a pulse-width modulation frequency to at least one seat heater member, and
at least one seat heater member being at least partially disposed at at least one out of the seat base cushion and the backrest cushion, and having electrical connection ends that are connected to the seat heater control unit for receiving the pulse-width modulated electrical heater power,
wherein the at least one seat heater member is electrically connected to the signal generating unit of the capacitive vehicle seat occupancy detection system.

8. A method of operating a capacitive vehicle seat occupancy detection system for use with a seat heater member of a vehicle seat, wherein a desired heating of the vehicle seat is designed to be carried out by providing pulse-width modulated electrical heater power of a pulse-width modulation frequency from a seat heater control unit that is connected to electrical connection ends of the at least one seat heater member, and wherein a time-varying output signal is being provided at least to the electrical connection ends of the at least one seat heater member for sensing an electrical quantity that is indicative of a capacitance of the at least one seat heater member, the capacitance being usable as a basis for at least one out of detecting and classifying a seat occupancy by comparison to at least a first predetermined value for the sensed capacitance, the method comprising steps of
monitoring a voltage difference between the electrical connection ends of the at least one seat heater member and
generating an output signal that is indicative of the at least one seat heater member being defective, when the voltage difference meets at least one predetermined condition.

9. The method according to claim 8, comprising the steps of
determining a voltage difference between the electrical connection ends of the at least one seat heater member,
checking if the determined voltage difference exceeds a predetermined third threshold value that is larger than zero, and
generating an output signal that is indicative of the at least one seat heater member to be defective if the determined voltage difference exceeds the predetermined third threshold value.

10. The method according to claim 8, wherein the seat heater comprises a seat heater control unit that is configured to alternately provide pulse-width modulated (PWM) electrical heater power to the at least one seat heater member during a PWM time interval (PWM cycle) and perform a diagnostic operation during a diagnostic time interval, said pulse-width modulated (PWM) electrical heater power being provided by periodically connecting and disconnecting one of said first and second connection end to, respective from, a respective one of a power source and ground, said method further comprising, during a first predetermined time interval of a length corresponding to the length of a PWM time interval, the steps of
a) sampling the monitored voltage difference periodically (n samples) and comparing the sampled voltage difference with a first threshold value (Vₜₕᵣₑₛₕ),
b) increase a counter value each time that the sampled voltage difference exceeds the first threshold value,
c) after the n samples, comparing the counter value with a predetermined second threshold value (Cₜₕᵣₑₛₕ), and
d) assessing that the seat heater member is not defective if said counter value is lower than said second threshold value (Cₜₕᵣₑₛₕ).

11. The method according to claim 10, further comprising, if in step c) said counter value is higher than or equal to said second threshold value, the steps of
monitoring, during a second predetermined time interval of a length corresponding to the length of a PWM time interval, said second predetermined time interval being adjacent to said first predetermined time interval, a voltage at the respective connection end that is disconnected from the respective one of ground or power source during a phase of the pulse-width modulated electrical heater power in which a momentary electrical heater power is zero, and
assessing that said seat heater member is not defective if a variation of the voltage at the respective connection end exceeds a specific threshold value during said second predetermined time interval or generating said output signal that is indicative of the at least one seat heater member to be defective if variation of the voltage at the switched connection end does not exceed said specific threshold value.

12. The method as claimed in claim 8, wherein the step of checking if the determined voltage difference exceeds a predetermined threshold value includes low-pass filtering of a voltage at one of the electrical connection ends of the at least one seat heater member.

13. A non-transitory digital memory unit comprising a software module having program code that is stored in the digital memory unit and that is executable by a processor unit of the capacitive vehicle seat occupancy detection system or a separate control unit to carry out the method of claim 8.
